(19) United States
(12) Patent Application Publication
(10) Pub. No.: US 2018/0173478 A1
(43) Pub. Date: Jun. 21, 2018

(54) IMAGE FORMING APPARATUS THAT SELECTS REFERENCE SIDE FOR PRINT POSITION ADJUSTING AND METHOD OF CONTROLLING IMAGE FORMING APPARATUS

(71) Applicant: CANON KABUSHIKI KAISHA, Tokyo (JP)

(72) Inventor: Takuya Hayakawa, Koshigaya-shi (JP)

(21) Appl. No.: 15/828,820

(22) Filed: Dec. 1, 2017

(30) Foreign Application Priority Data
Dec. 21, 2016 (JP) 2016-247816

(51) Int. Cl. G03G 15/01; G06F 3/12; G06K 15/12

(52) U.S. Cl. CPC G06F 3/1252; G06K 15/1219; G06F 3/1265; G03G 15/0806; G03G 15/5008; G03G 15/5062; G03G 15/607

(57) ABSTRACT

An image forming apparatus that corrects a print position of an image using an optimum reference side of a sheet when performing print position adjustment. Image data is converted based on conversion conditions. An image on a sheet is formed based on the converted image data. On the sheet, the image forming unit forms a test image for detecting a misalignment of a position of an image to be formed on a first surface of the sheet and a position of an image to be formed on a second surface, which is different from the first surface, of the sheet. Read data is acquired which is read from the test image and output from a reading device, and the conversion conditions are generated based on the read data and a selected reference position of the sheet.

### BACKGROUND OF THE INVENTION

### Field of the Invention

The present invention relates to an image forming apparatus that is equipped with an adjustment function for adjusting a print position, and selects a reference side for print position adjustment.

### Description of the Related Art

Conventionally, an image forming apparatus is equipped with an adjustment function for adjusting a print position such that an image is formed on a sheet at a position intended by a user. With provision of the adjustment function, the image forming apparatus is capable of performing print position alignment at a high level e.g. in a case where an image is printed on a sheet, such as a preprinted sheet, which is printed with guidelines or the like in advance, or in a case where double-sided printing in which alignment of front and reverse sides of a sheet is required.

Incidentally, the print position adjustment is required to be performed for each type of sheets in use. This is because the conveying characteristics of a sheet, dependent on the size, basis weight (weight), sheet material, etc. of the sheet, has an influence on writing start positions, magnifications, and skew characteristics, which leads to minute differences between the print positions. Further, due to differences in hygroscopicity of sheets, fixing heat generated when printing is performed on a first surface (front side) of each sheet causes shrinkage of the sheet at a different shrinkage rate, which sometimes has an influence on the print position and expansion/reduction rate when printing is performed on a second surface (reverse side) of the sheet.

When adjusting the print position, a test sheet is used on which predetermined marks are printed at respective predetermined positions of a sheet to be subjected to the adjustment. More specifically, a misalignment amount of the print position is determined based on relative positions of the predetermined marks on the test sheet, and the determined misalignment amount is stored as an adjustment parameter of the sheet. After that, when performing printing on the sheet, the print position is adjusted with reference to the adjustment parameter of the sheet such that the misalignment amount is canceled out.

There has been proposed a method in which an operator measures positions of marks printed on a test sheet, using a ruler or the like, and inputs the measured positions to a printing apparatus. This method, however, not only requires time and effort of the operator, but also sometimes causes an error since the positions of the marks are measured by man. Therefore, depending on the misalignment amount of a print position that is determined based on the measured positions of the marks thus input, it is sometimes impossible to accurately adjust the print position.

To solve this problem, there has been proposed a method in which a test sheet is read using an image reader, such as a scanner, and a scanned image which is read out is analyzed to automatically detect positions of marks with high accuracy, whereby position misalignment is detected based on the detected positions of the marks, and the print position is adjusted based on the detected position misalignment (Japanese Laid-Open Patent Publication (Kokai) No. 2003-173109).

In a case where the print position of an image is adjusted based on the technique disclosed in Japanese Laid-Open Patent Publication (Kokai) No. 2003-173109, it is envisaged to deform the shape of a print image e.g. by right-angle correction, trapezoidal correction, and magnification correction, and adjust the print position such that one side of an image forming region becomes parallel to one side (edge) of a sheet. One side of the sheet used as a reference for making the image parallel to a specific side of the sheet when adjusting the print position on the sheet is called e.g. a “reference side”.

According to the technique disclosed in Japanese Laid-Open Patent Publication (Kokai) No. 2003-173109, a sheet having at least one alignment mark formed on each of a front side and a reverse side thereof is read by an image reading unit, and the print position is adjusted based on the read information. According to this technique, it is possible to automatically detect the marks printed on the test sheet with high accuracy, and hence the operation error of an operator is reduced and the accuracy of detection of positions of the marks is improved.

However, the technique can be properly applied insofar as the sheet has e.g. a rectangular shape of which four inner angles are all right angles (e.g. a regular size rectangle), but all sheets do not necessarily have four inner angles which are all right angles. In the case of a sheet other than the sheet of which the four inner angles are all right angles, in other words, in a case where the sheet has a trapezoidal or parallelogram shape, for example, even when skew correction of an image is performed such that the image becomes parallel to a reference side of the sheet, parallelism between the image and the sheet sides other than the reference side is not guaranteed.

Further, normally, a reference side for skew correction of an image is univocally determined by the registration configuration of an apparatus. For example, in the case of a configuration in which a skew of a sheet is corrected by abutting the sheet on a conveying roller at rest, skew correction of the sheet is performed with reference to the leading edge of the sheet, and hence the skew correction should be performed such that the image becomes parallel to the leading edge of the sheet. Further, in the case of a configuration in which a skew of a sheet is corrected by abutting the sheet on an abutment member parallel to a conveying path through which the sheet is conveyed, skew of the sheet is corrected with reference to the left edge, for example, of the sheet, and hence the skew correction should be performed such that the image becomes parallel to the left edge of the sheet. Note that in a case where a reference side univocally determined according to a type of skew correction and a reference side for print position adjustment are different, it is impossible to always obtain a high-quality image since skew correction is performed in a manner dependent on the shape of a sheet.

### SUMMARY OF THE INVENTION

The present invention provides an image forming apparatus that corrects the print position of an image using an optimum reference side when performing print position adjustment.

In a first aspect of the present invention, there is provided an image forming apparatus comprising a conversion unit configured to convert image data based on conversion conditions, an image forming unit configured to form an image on a sheet based on the image data converted by the conversion unit, a selection unit configured to select a reference position of the sheet, and a controller configured to control the image forming unit to form a test image on the sheet, acquire read data related to the test image formed on the sheet by the image forming unit, and generate the conversion conditions based on the read data and the reference position selected by the selection unit, wherein the test image is used for detecting a misalignment of a position of an image to be formed on a first surface of the sheet by the image forming unit and a position of an image to be formed on a second surface, which is different from the first surface, of the sheet by the image forming unit, and wherein the read data is output from a reading device.

In a second aspect of the present invention, there is provided a method of controlling an image forming apparatus that forms an image on a sheet based on image data, comprising selecting a reference position of the sheet, forming a test image on the sheet, reading the test image formed on the sheet, generating correction data based on a result of reading of the test image and the reference position, and performing image processing on the image data based on the correction data, so as to correct misalignment between a position of an image to be formed on a first surface of the sheet and a position of an image to be formed on a second surface, which is different from the first surface, of the sheet.

In a third aspect of the present invention, there is provided a method of controlling an image forming apparatus including an image forming unit that forms an image on a sheet, and a first and a second processing units that perform post-processing on the sheet, comprising selecting a reference position of the sheet, forming a test image on the sheet, reading the test image formed on the sheet, generating correction data based on a result of reading of the test image and the reference position, and performing image processing on the image data based on the correction data, so as to correct misalignment between a position of an image to be formed on a first surface of the sheet and a position of an image to be formed on a second surface, which is different from the first surface, of the sheet, wherein said selecting includes selecting a first reference position in a case where the first post-processing unit performs post-processing on the sheet, and wherein said selecting includes selecting a second reference position in a case where the second post-processing unit performs post-processing on the sheet.

According to the present invention, it is possible to correct the print position of an image using an optimum reference side of the sheet.

Further features of the present invention will become apparent from the following description of exemplary embodiments (with reference to the attached drawings).

### BRIEF DESCRIPTION OF THE DRAWINGS

FIG. 1 is a schematic cross-sectional view of an image forming system including an image forming apparatus according to an embodiment of the present invention.

FIG. 2 is a view useful in explaining skew correction performed by conveying rollers appearing in FIG. 1.

FIG. 3 is a control block diagram of the image forming system shown in FIG. 1.

FIGS. 4A and 4B are schematic diagrams showing an example of a test sheet used for print position adjustment.

FIGS. 5A to 5C are diagrams useful in explaining a method of synthesizing image data of an image toward the leading edge of the test sheet, and image data of an image toward the trailing edge of the test sheet, which are read separately from each other.

FIG. 6 is a flowchart of a print position adjustment process performed by the image forming apparatus appearing in FIG. 1.

FIG. 7 is a view showing a screen displayed on a console section, for designating whether or not to execute on-line post-processing.

FIGS. 8A to 8G are diagrams useful in explaining a method of calculating a misalignment amount of a print position and a method of adjusting the print position with reference to the left edge.

FIGS. 9A to 9G are diagrams useful in explaining a method of calculating a misalignment amount of a print position and a method of adjusting the print position with reference to the leading edge.

FIG. 10 is a view showing a screen for designating a reference side selection mode for print position adjustment.

FIG. 11 is a view showing a screen for selecting a reference side for print position adjustment.

FIG. 12 is a flowchart of a reference side selection process performed in a step in FIG. 6 for print position adjustment.

FIG. 13 is a view showing a selection screen displayed on the console section, for selecting a type of prost-processing.

### DESCRIPTION OF THE EMBODIMENTS

The present invention will now be described in detail below with reference to the accompanying drawings showing embodiments thereof.

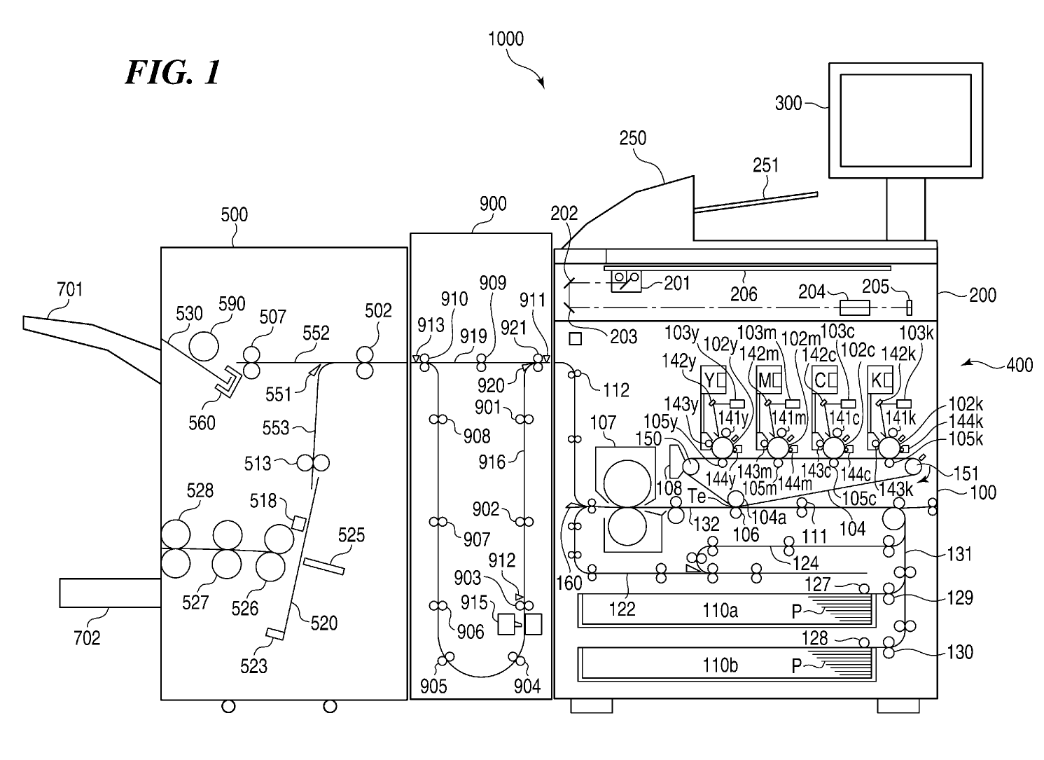

FIG. 1 is a schematic cross-sectional view of an image forming system including an image forming apparatus according to an embodiment of the present invention. The image forming system, denoted by reference numeral 1000, is comprised of the image forming apparatus, denoted by reference numeral 400, a puncher 900, and a finisher 500.

Referring to FIG. 1, the image forming apparatus 400 includes an image forming apparatus body (hereinafter referred to as the “printer”) 100, as well as an image reader 200 and a console section 300 provided above the printer 100.

The image reader 200 is comprised of an original feeder section 250 including an original tray 251 and a tray, not shown, and a platen glass 206. The image reader 200 includes, below the platen glass 206, a scanner unit 201, mirrors 202 and 203 for receiving light irradiated from a light source of the scanner unit 201 and reflected by a surface of an original, a lens 204, and an image sensor 205.

The original feeder section 250 feeds originals set on the original tray 251 with their front surfaces facing upward, one by one, starting with the leading page, such that each original is guided along a curved conveyance path, then conveyed on the platen glass 206 through a predetermined reading position, and discharged onto the tray, not shown.

The image sensor 205 reads an image from the original fed by the original feeder section 250 when the original is passing the reading position on the platen glass 206 from the left to the right as viewed in FIG. 1. The reading position is a predetermined position at which reading of an original is performed on the platen glass 206, and the predetermined position is a position on the platen glass 206, which is opposed to a position at which the scanner unit 201 is fixed. When the original passes the reading position on the platen glass 206, an original image is read by the image sensor 205 via the scanner unit 201 fixed or held in opposed relation to the reading position.

At this time, light emitted from the light source of the scanner unit 201 is irradiated onto a surface of the original, and light reflected from the original is guided to the lens 204 via the mirrors 202 and 203. The light having passed through the lens 204 forms an image on an image pickup surface of the image sensor 205, whereby the original image is read. The optically read image is converted to image data by the image sensor 205, and the image data is output. In a case of copying the original, the image data output from the image sensor 205 is input to exposure devices, described hereinafter, of the printer 100 as video signals.

Next, a description will be given of the configuration of the printer 100.

The printer 100 includes a plurality of image forming stations. The image forming stations form images of yellow (Y), magenta (M), cyan (C), and black (K). The image forming stations have the same configuration, and include photosensitive drums 102y, 102m, 102c, and 102k as photosensitive members which are rotatably supported on rotating shafts, not shown, respectively. The photosensitive drums 102y, 102m, 102c, and 102k each function as an image bearing member. In opposed relation to outer peripheral surfaces of the respective photosensitive drums 102y, 102m, 102c, and 102k, there are arranged chargers 141y, 141m, 141c, and 141k, exposure devices 103y, 103m, 103c, and 103k, reflection mirrors 142y, 142m, 142c, and 142k, developing units 143y, 143m, 143c, and 143k, and cleaners 144y, 144m, 144c, and 144k, respectively.

The printer 100 includes an intermediate transfer belt 104 in the form of an endless belt. Similar to each photosensitive drum 102 (generically representing 102y, 102m, 102c, and 102k), the intermediate transfer belt 104 functions as an image bearing member, and is rotatably stretched by a drive roller 150, a tension roller 151, and a secondary transfer opposed roller 104a, for example. A secondary transfer roller 106 is disposed in opposed relation to the secondary transfer opposed roller 104a. A contact portion of the secondary transfer roller 106 and the secondary transfer opposed roller 104a forms a secondary transfer section Te.

Primary transfer rollers 105y, 105m, 105c, and 105k as primary transfer members are disposed in opposed relation to the photosensitive drums 102y, 102m, 102c, and 102k via the intermediate transfer belt 104, respectively. Respective contact portions of the photosensitive drums 102y to 102k and the primary transfer rollers 105y to 105k form primary transfer sections.

A conveyance path along which a sheet P is conveyed to the secondary transfer section Te, and a sheet storage section for storing sheets P are disposed below the intermediate transfer belt 104. The sheet storage section is comprised of an upper cassette 110a and a lower cassette 110b. The upper cassette 110a and the lower cassette 110b are each provided with a paper-out sensor and an opening/closing sensor, not shown. The paper-out sensor detects a paper out when sheets P in the associated cassette run out. Further, the opening/closing sensor detects opening/closing of the associated cassette.

The upper cassette 110a and the lower cassette 110b are capable of stacking a plurality of sheets P therein. The upper and lower cassettes 110a and 110b store sheets of regular sizes, such as the A3 size and the A4 size. The upper and lower cassettes 110a and 110b have restriction plates, not shown, provided in a sheet conveying direction and a direction intersecting with the sheet conveying direction, respectively. A user stacks sheets P in each of the upper and lower cassettes 110a and 110b, and thereafter restricts a position of the sheets P by moving the restriction plates such that the restriction plates are brought into contact with the edges of the sheets P. Sheets P of the same size may be accommodated in the upper and lower cassettes 110a and 110b. Note that a CPU 601, described hereinafter, is capable of identifying the sizes of sheets stacked in the upper and lower cassettes 110a and 110b based on the positions of the restriction plates.

The conveyance path is comprised of a supply path 131 for conveying sheets P from the upper cassette 110a or the lower cassette 110b to the secondary transfer section Te, and a discharge path 132 for discharging sheets P having been subjected to image formation, out of the image forming apparatus 400. On the supply path 131, there are provided pickup rollers 127 and 128 and conveying rollers 129 and 130, which are associated with the upper and lower cassettes 110a and 110b, respectively, as well as a registration roller 111. A fixing device 107 is disposed on the discharge path 132, and an inversion path 122 is connected to the discharge path 132 at a location downstream of the fixing device 107. Further, a double-sided conveyance path 124 is connected to the inversion path 122. On the discharge path 132, there are arranged a switching flapper 160 at a portion of the discharge path 132 downstream of the fixing device 107, where the inversion path 122 is branched from the discharge path 132, and a discharge roller 112 for discharging sheets P toward the outside of the image forming apparatus 400.

Next, a description will be given of a basic printing operation by the image forming apparatus 400. Video signals generated by reading an original by the image reader 200 via the scanner unit 201 thereof, or image data items transferred from an external apparatus, such as a PC, are subjected to image processing, and are then input to the exposure devices 103. The video signals and the image data items include multi-value image signals indicative of the densities of a plurality of pixels constituting the image. The exposure devices 103 irradiate laser lights corresponding to the image signals onto associated ones of the photosensitive drums 102 to thereby form electrostatic latent images of associated colors on the respective photosensitive drums 102. The electrostatic latent images formed on the photosensitive drums 102 are developed by the developing units 143 (generically representing 143y, 143m, and 143c, and 143k). Toner images of color components corresponding to the respective colors of yellow (Y), magenta (M), cyan (C), and black (K) are formed on the photosensitive drums 102y to 102k, respectively. The respective toner images formed on the photosensitive drums 102 are primarily transferred onto the intermediate transfer belt 104 in predetermined timings, and the color components are superimposed one upon another, whereby a desired color image is formed on the intermediate transfer belt 104.

On the other hand, for example, a sheet P fed from the upper cassette 110a is conveyed to the registration roller 111 which is at rest. After the leading edge of the sheet P has reached the registration roller 111, the registration roller 111 is driven in a desired timing, and the sheet P is conveyed to the secondary transfer section Te in synchronism with the above-mentioned laser light irradiation processing and development processing. Skew of the sheet P is thus corrected by causing the sheet P to be brought into abutment with the registration roller 111 at rest, and then conveying the sheet P again in a predetermined timing. At the secondary transfer section Te, the color image on the intermediate transfer belt 104 is transferred onto the sheet P. After the color image on the intermediate transfer belt 104 is transferred onto the sheet P, toner remaining on the intermediate transfer belt 104 is removed by an intermediate transfer belt cleaning section 108.

The sheet P having the color image transferred thereon is conveyed into the fixing device 107, where the transferred color image of toners is fixed on the sheet P by being heated and pressed. The sheet having the color image fixed thereon is discharged toward the puncher 900 disposed downstream of the image forming apparatus 400 by the discharge roller 112, for example.

Next, a description will be given of the configuration of the puncher 900.

As shown in FIG. 1, the puncher 900 has a conveyance path 919 for conveying a sheet P conveyed into the puncher 900 without performing punching thereon, and a U-shaped punching path 916 for conveying a sheet P conveyed into the puncher 900, for performing punching thereon. On the conveyance path 919, there are arranged conveying rollers 921, 909, and 910 along a direction of conveying the sheet P in the mentioned order. A conveyance sensor 911 is disposed upstream of the conveying roller 921. Further, a conveyance sensor 913 is disposed downstream of the conveying roller 910. The U-shaped punching path 916 has an inlet portion thereof connected to the conveyance path 919 at a location downstream of the conveying roller 921, and an outlet portion thereof connected to the conveyance path 919 at a location upstream of the conveying roller 910.

At a connection portion between the conveyance path 919 and the inlet portion of the conveyance path 916, there is provided a switching flapper 920. Further, on the punching path 916, there are arranged conveying rollers 901, 902, and 903, a punching unit 915, and conveying rollers 904, 905, 906, 907, and 908 along a direction of flow of the sheet P in the mentioned order. At a location upstream of the punching unit 915, there is disposed a conveyance sensor 912.

The puncher 900 configured as above sequentially takes in sheets P discharged from the image forming apparatus 400 and punch holes in each of the sheets P, as required. Whether or not to punch holes is determined based on e.g. an instruction from the CPU 601, described hereinafter, of the image forming apparatus 400.

When punching is not to be performed on a sheet P discharged from the image forming apparatus 400, the sheet P is guided into the conveyance path 919 via the conveying roller 921 and the switching flapper 920, and is conveyed to the finisher 500 as a downstream apparatus by the conveying rollers 909 and 910. On the other hand, when punching is to be performed on a sheet P discharged from the image forming apparatus 400, the sheet P is taken into the punching path 916 via the conveying roller 921 and the switching flapper 920. The sheet P taken into the punching path 916 is conveyed into the punching unit 915 via the conveying rollers 901, 902, and 903.

The conveying rollers 902 and 903 disposed upstream of the punching unit 915 are each configured to correct skew of a sheet P by performing skew feeding of the sheep P.

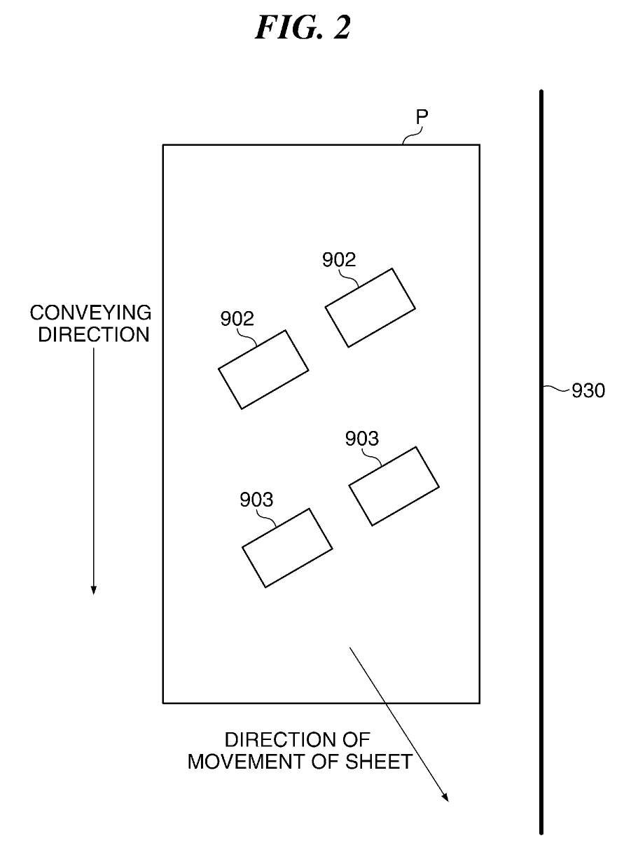

Hereinafter, skew correction performed by the conveying rollers 902 and 903 will be described with reference to FIG. 2.

FIG. 2 is a view useful in explaining the skew correction performed by the conveying rollers appearing in FIG. 1. Referring to FIG. 2, the conveying rollers 902 and 903 are disposed in a manner inclined through a predetermined angle with respect to a conveying direction (downward, as viewed in FIG. 2). When a sheet P has reached the conveying roller 902 in a driven state, the sheet P is conveyed while being moved toward a conveyance path side end 930. That is, the sheet P is conveyed by the conveying rollers 902 and 903 while bringing the left edge of the sheet P as viewed in the direction of conveying the sheet P into abutment with the conveyance path side end 930, whereby skew of the sheet P is corrected with reference to the left edge of the sheet P.

After that, the sheet P is guided into the punching unit 915, where predetermined holes are punched by the punching unit 915 at predetermined locations of the sheet P. The sheet P having the holes punched therein is conveyed out of the punching unit 915. Then, the sheet P is discharged from the puncher 900 via the conveying rollers 904, 905, 906, 907, 908, and 910, and is conveyed into the finisher 500. The conveyance path 919 and the punching path 916 are provided with the conveyance sensors 911, 912, and 913, each of which detects passage of the sheet P.

Next, a description will be given of the configuration of the finisher 500.

Referring to FIG. 1, the finisher 500 includes a finisher path 552 for conveying a sheet P conveyed into the finisher 500 to a tray 701 via an intermediate tray 530 having a discharge roller 590 and a stapler 560. Further, the finisher 500 includes a finisher path 553 for conveying a sheet P conveyed into the finisher 500 to a tray 702 via a storage guide 520 having a pair of staplers 518, a thrusting member 525, and a positioning member 523.

The finisher path 552 has an inlet roller 502. The finisher path 553 is connected to the finisher path 552 at a location downstream of the inlet roller 502. A switching flapper 551 is disposed at a connection portion between the finisher path 552 and the finisher path 553. Further, a conveying roller 507 is disposed on the finisher path 552 at a location upstream of the intermediate tray 530.

On the other hand, a conveying roller 513 is disposed on the finisher path 553 at a location upstream of the storage guide 520. A folding roller 526 is disposed in opposed relation to the thrusting member 525 of the storage guide 520. At respective locations downstream of the folding roller 526, there are sequentially provided an intermediate roller 527 and a discharge roller 528.

The finisher 500 configured as above takes in sheets P having been conveyed from the image forming apparatus 400 via the puncher 900, and performs post-processing on the sheets P. More specifically, the finisher 500 performs e.g. bundling for aligning a plurality of sheets P into a bundle, and stapling (stitching) for stitching a trailing end of the sheet bundle with staples. Further, the finisher 500 performs sorting, non-sorting, bookbinding, etc. The finisher 500 is provided with an on-line post-processing function for performing the post-processing on the sheets P.

Next, a detailed description will be given of the post-processing performed by the finisher 500.

In a case where the post-processing other than bookbinding is performed, sheets P conveyed into the finisher 500 via the inlet roller 502 are guided into the finisher path 552. The sheets P having been guided into the finisher path 552 are discharged onto the intermediate tray 530 via the conveying roller 507. The sheets P having been discharged onto the intermediate tray 530 are aligned by an alignment plate (not shown) disposed to extend from the near side to the far side with respect to the sheet surface of FIG. 1, and the discharge roller 590. After a number of sheets P corresponding to a sheet bundle have been aligned, in a case where stitching is to be performed, the stapler 560 performs stitching on the sheets P. Then, the sheet bundle is discharged onto the tray 701 by the discharge roller 590.

On the other hand, in a case where bookbinding is performed, sheets P conveyed into the finisher 500 via the inlet roller 502 are guided into the finisher path 553. A predetermined number of the sheets P guided into the finisher path 553 are stored in the storage guide 520 via the conveying roller 513. Each of the predetermined number of the sheets P, which are stored in the storage guide 520, is conveyed until the leading edge thereof is brought into abutment with the positioning member 523 which is a movable sheet positioning member, to form a sheet bundle.

Stitching of the sheet bundle stored in the storage guide 520 is performed by stitching the center of the sheets of the sheet bundle by the pair of the staplers 518 provided at an intermediate location of the storage guide 520. After termination of the stitching by the staplers 518, the positioning member 523 is moved downward by a predetermined distance from where it is positioned at the time of stapling, such that the stapled position of the sheet bundle matches the central position (nip point) of the folding roller 526. This causes the position of the sheet bundle where the stapling has been performed to be opposed to the central position of the folding roller 526.

Then, the thrusting member 525 is thrust toward the sheet bundle stored in the storage guide 520 to thrust the sheet bundle between the rollers of the folding roller 526, whereby the sheet bundle is conveyed while being folded by the folding roller 526. As described above, the sheet bundle is folded at the position where the sheet bundle has been stapled, as the center. The folded sheet bundle is then conveyed by the intermediate roller 527, and is discharged onto the tray 702 via the discharge roller 528.

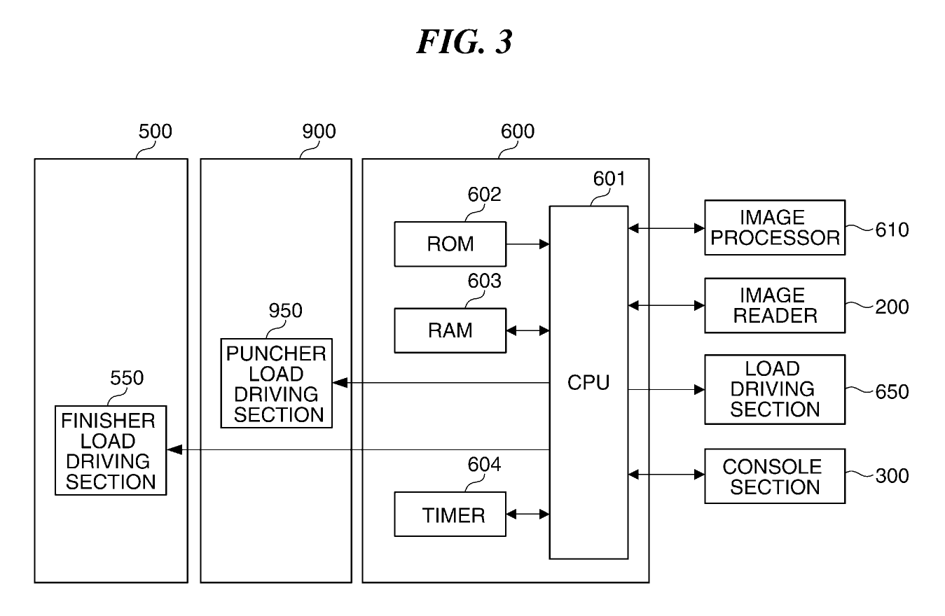

Next, a description will be given of the control configuration of the image forming system 1000 shown in FIG. 1. FIG. 3 is a control block diagram of the image forming system 1000 shown in FIG. 1.

Referring to FIG. 3, the image forming apparatus 400 includes a system controller 600 that incorporates the CPU 601, a ROM 602, a RAM 603, and a timer 604. The CPU 601 is connected to the ROM 602, the RAM 603, and the timer 604. Further, the CPU 601 is connected to an image processor 610, the image reader 200, a load driving section 650, and the console section 300, via an address bus or a data bus. The CPU 601 is further connected to a puncher load driving section 950 of the puncher 900 and a finisher load driving section 550 of the finisher 500, via an address bus or a data bus.

The system controller 600 performs centralized control over the components of the image forming system 1000. More specifically, the system controller 600 plays the roles of driving loads in the image forming system 1000, collecting and analyzing information from the sensors and the like, and exchanging data not only with the image processor 610 but also with the console section 300 and so forth. Further, the system controller 600 sends required data of specification settings of each component to the image processor 610. Furthermore, the system controller 600 receives signals, such as original image signals and density signals, from the image reader 200, and perform calculations and configurations so as to cause the image processor 610 to perform optimum image formation.

The CPU 601 mounted on the system controller 600 performs various sequences related to a predetermined image forming sequence according to programs stored in the ROM 602. Further, the CPU 601 controls the puncher load driving section 950 that drives the conveying rollers 901 to 910 of the puncher 900. Further, the CPU 601 controls the finisher load driving section 550 that drives loads on the positioning member 523 and the like of the finisher 500.

The ROM 602 stores various programs executed by the CPU 601. The RAM 603 stores rewritable data required to be temporarily stored. The RAM 603 stores e.g. image forming command information sent from the console section 300. The RAM 603 may be replaced by a nonvolatile memory which is capable of storing data permanently. The console section 300 receives information input by the user, such as a copy magnification and a density setting value, and receives data for informing the user of statuses of the image forming apparatus 400, such as the number of sheets subjected to image formation, information on whether or not image formation is being performed, occurrence of a jam, and a location where the jam has occurred, to display the information and data.

Hereinafter, a description will be given of a test sheet which is used in a print position adjustment process performed by the image forming apparatus 400 appearing in FIG. 1.

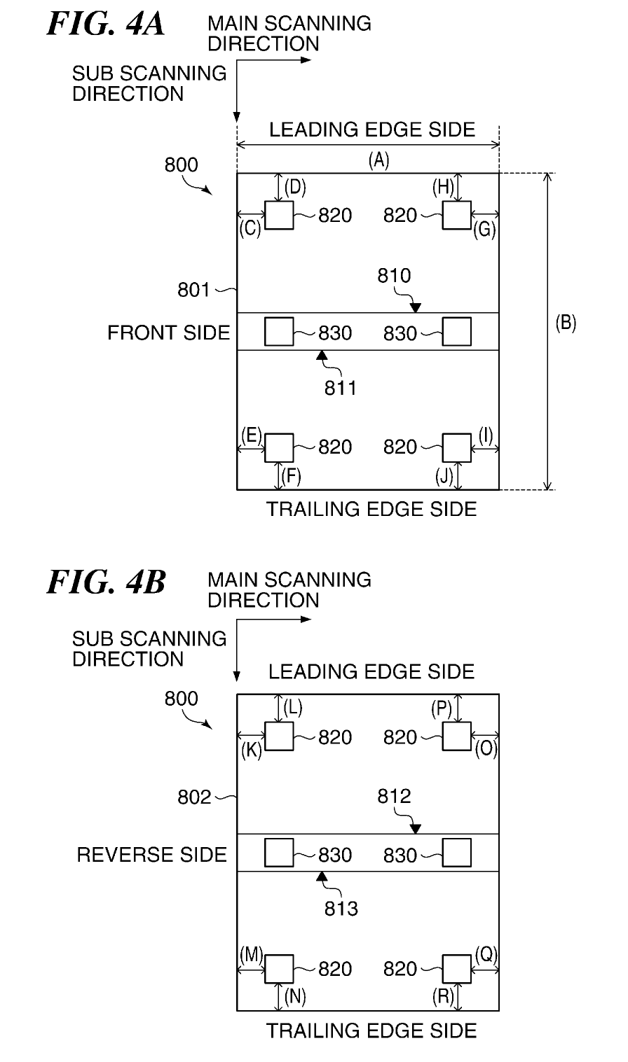

FIGS. 4A and 4B are schematic diagrams showing an example of the test sheet used for print position adjustment. FIGS. 4A and 4B show a front side 801 and a reverse side 802 of the test sheet 800, respectively. Marks are printed on both of the front side 801 and the reverse side 802 of the test sheet 800.

In the following description, since a range within which the image reader 200 can read data is limited, it is assumed that the test sheet 800 is divided into two regions to separately read data from the two regions. In the following description, the term “leading edge-side read data of the test sheet 800” refers to data obtained by reading from a region including the leading edge of the test sheet 800 as viewed in a direction in which the test sheet 800 is conveyed. Also, the term “trailing edge-side read data of the test sheet 800” refers to data obtained by reading from a region including the trailing edge of the test sheet 800 as viewed in the direction in which the test sheet 800 is conveyed. Note that when there is no need to adjust a print position on the reverse side of a sheet, the CPU 601 can determine distances from four edges of the test sheet 800 to the ends of an image forming region, based on the leading edge-side read data and trailing edge-side read data of the front side of the test sheet 800.

Triangle marks 810 to 813 are used as markers for alignment of the test sheet 800 when an operator places the test sheet 800 on a reading surface of the image reader 200. The colors of the triangle marks 810 to 813 are red, blue, cyan, and magenta, respectively, for example. The triangle marks 810 to 813 indicate to the operator e.g. an order in which the test sheet 800 is to be caused to be read.

Square marks 820 are formed at respective four corners of the front and reverse sides of the test sheet 800. The square marks 820 are normally formed using toner of a color having a large difference in reflectance from the sheet. The square marks 820 are formed by black toner, for example.

The square marks 820 are printed on the four corners of each of the front side 801 and the reverse side 802 of the test sheet 800, i.e. on eight portions of the test sheet 800. Each square mark 820 is printed at a position a predetermined distance away from sheet edges of the test sheet 800 assuming that the print position is ideally set. The misalignment amount of the print position is determined by measuring relative positions of the square marks 820 in a read image on the test sheet 800 with respect to the square marks 820 in a print image on the same. Note that by identifying and adjusting the print position using the test sheet 800 having a plurality of marks formed thereon, it is possible to improve the accuracy of print position adjustment.

In FIGS. 4A and 4B, the lengths of portions represented by alphabets (A), (B), (C), (D), (E), (F), (G), (H), (I), (J), (K), (L), (M), (N), (O), (P), (Q), and (R) represent measured values for print position adjustment. (A) and (B) represent the lengths of the test sheet 800 in a main scanning direction and a sub scanning direction, respectively. The length of the test sheet 800 in the main scanning direction refers to a length thereof in a direction orthogonal to the conveying direction of a conveyed sheet P, and the length of the test sheet 800 in the sub scanning direction refers to a length thereof along the conveying direction of the conveyed sheet P.

Further, (C) to (R) represent distances from the respective square marks 820 to sheet edges closest thereto. Ideally, the square marks 820 are printed at respective positions e.g. 1 cm away from the sheet edges associated therewith. A range, which is surrounded by the square marks 820 provided at the positions e.g. 1 cm away from the sheet edges, and includes the square marks 820, is referred to as an effective area of the sheet P, for convenience′ sake. In a case where a plurality of the test sheets 800 are output so as to adjust the print position, a value obtained by averaging a plurality values of each of the lengths (C) to (R) is used as each value of the lengths (C) to (R).

Further, in FIGS. 4A and 4B, there are provided two square-shaped reference marks 830 at a central portion of each of the front side 801 and the reverse side 802 of the test sheet 800 in the sub scanning direction. The reference marks 830 are used as references when leading edge-side read data and trailing edge-side read data of the test sheet 800 are synthesized after image reading is separately performed from the leading edge-side and trailing edge-side of the test sheet 800. The reference marks 830 are printed on two portions of each of the front side 801 and the reverse side 802 of the test sheet 800, i.e. on four portions of the test sheet 800.

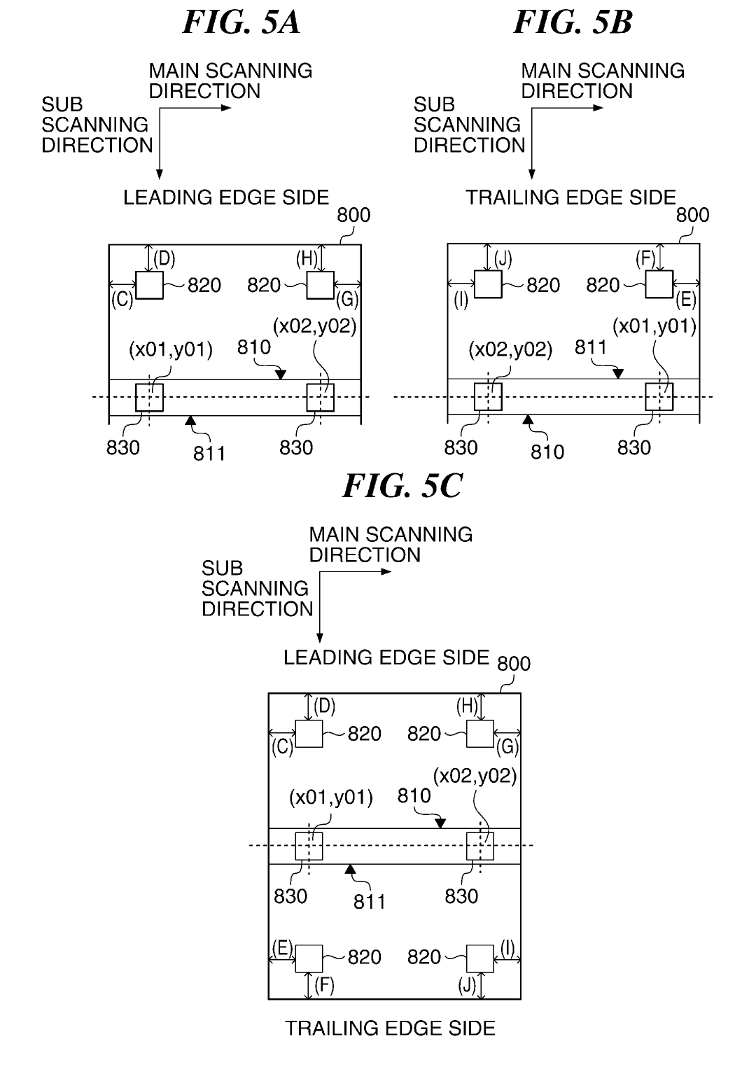

When reading an image on the test sheet, it is possible to cause part of the image toward the leading edge and part of the same toward the trailing edge to be read separately from each other, and then synthesize images thus read, into a single read image. A method of synthesizing image data items of images in a case where a leading edge-side part and a trailing edge-side part of the test sheet 800 are separately read will be described with reference to FIGS. 5A to 5C.

FIGS. 5A to 5C are diagrams useful in explaining the method of synthesizing image data items of an image toward the leading edge of the test sheet and an image toward the trailing edge of the test sheet, which are read separately from each other.

FIG. 5A shows the image data read from the leading edge-side part of the front side 801 of the test sheet 800. FIG. 5B shows the image data read from the trailing edge-side part of the front side 801 of the test sheet 800 by interchanging the leading edge and the trailing edge.

Referring to FIGS. 5A and 5B, the reference marks 830 are read in both of the case where image reading is performed from the leading edge-side part of the test sheet 800 and the case where image reading is performed from the trailing edge-side part of the test sheet 800. The coordinates of the centers of the images of the two reference marks 830 are represented by (x01, y01) and (x02, y02), and the image data items are synthesized such that the coordinates (x01, y01) and (x02, y02) in FIGS. 5A and 5B match each other. This makes it possible to obtain image data synthesized as shown in FIG. 5C, and hence variation in image reading from an original is increased.

Next, a description will be given of the print position adjustment process performed by the image forming apparatus 400 appearing in FIG. 1.

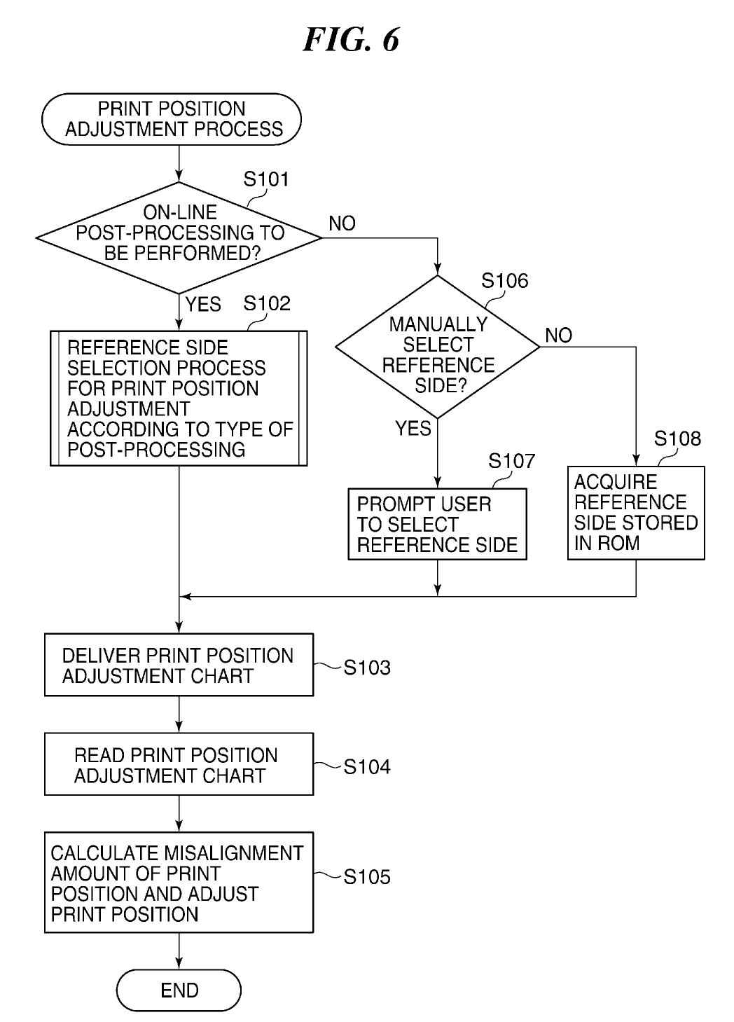

FIG. 6 is a flowchart of the print position adjustment process performed by the image forming apparatus 400 appearing in FIG. 1. The print position adjustment process is performed by the CPU 601 incorporated in the system controller 600 of the image forming apparatus 400 according to a print position adjustment program stored in the ROM 602.

Referring to FIG. 6, when the print position adjustment process is started, first, the CPU 601 determines whether or not a sheet to be subjected to the print position adjustment process is to be subjected to on-line post-processing after execution of the image forming process (step S101). The CPU 601 determines a side of the sheet (reference side) which is to be used as a reference for skew correction during print position adjustment, according to a type of the post-processing.

The post-processing refers to processing which the puncher 900 or the finisher 500 disposed downstream of the image forming apparatus 400 performs on a sheet having an image formed thereon, according to settings made in advance. Examples of the post-processing include folding, punching, stapling, sorting, bundling, and bookbinding. Whether or not to perform the on-line post-processing on the sheet to be subjected to print position adjustment is set by the user via the console section 300.

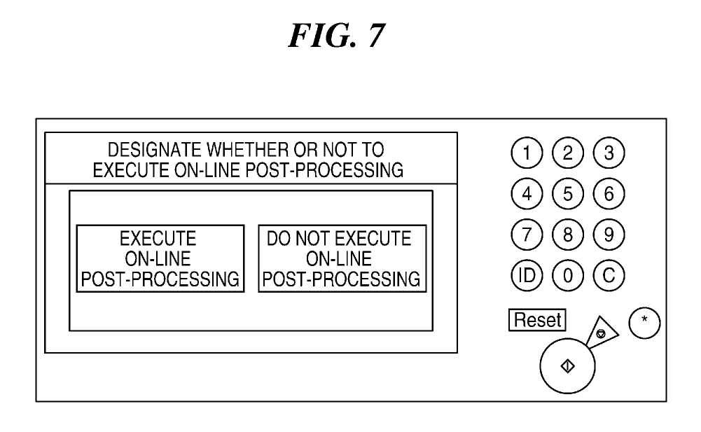

FIG. 7 is a view showing a screen displayed on the console section 300, for designating whether or not to execute on-line post-processing. Referring to FIG. 7, a display screen of the console section 300 shows an on-line post-processing execution button and an on-line post-processing non-execution button for use in designating whether or not to execute the on-line post-processing. The user selects, in advance, whether or not to execute the on-line post-processing, by pressing the on-line post-processing execution button or the on-line post-processing non-execution button.

If it is determined in the step S101 that the on-line post-processing is to be executed (YES to the step S101), the CPU 601 performs a reference side selection process for selecting a reference side, which is to be applied to the skew correction during print position adjustment, according to a type of the post-processing (step S102). The reference side selection process will be described in detail hereinafter.

After execution of the reference side selection process (step S102), the CPU 601 causes a test sheet to be delivered on which a print position adjustment image is printed (step S103). In doing this, the CPU 601 receives a print position adjustment sequence start signal from the console section 300, and controls the image forming apparatus 400 to perform a series of image forming operations so as to deliver the test sheet. The test sheet on which the print position adjustment image is printed is hereinafter also referred to as the print position adjustment chart (“the chart” in a simplified form).

After delivering the print position adjustment chart (test sheet) (step S103), the CPU 601 controls the image reader 200 to read the chart which is printed by the printer 100 of the image forming apparatus 400, discharged out of the image forming system 1000, and set on the original tray 251, by the scanner unit 201 (step S104). In doing this, the print position adjustment chart (test sheet) discharged out of the image forming system 1000 is moved to the original tray 251 of the image reader 200 by the user. More specifically, a reading procedure is displayed on the console section 300, and the user causes the image reader 200 to read the chart in a state in which the colors of the triangle marks 810 to 813 of the test sheet are caused to match the colors of the marks shown by a displayed reading guidance.

Although the description is given of the example in which the reading procedure is instructed using the colors of the triangle marks 810 to 813, the shapes, sizes, colors, etc. of them are not particularly limited insofar as the reading procedure is clearly shown to the operator. Further, although the reading of the print position adjustment chart is performed using the image reader 200, the reading of the chart may be performed using the scanner unit which is not connected to the image forming apparatus 400, and data obtained by the reading may be transmitted to the image forming apparatus 400.

After the print position adjustment chart (test sheet) has been read (step S104), the CPU 601 proceeds to a step S105. More specifically, the CPU 601 determines the misalignment amount of the print position based on results of reading by the scanner unit, and calculates adjustment values for correcting writing start positions in the main scanning direction and the sub scanning direction, magnification, and skew, as the adjustment values for correcting the misalignment amount. Then, the CPU 601 adjusts the print position based on the calculated adjustment values (step S105). After adjusting the print position based on the print position adjustment values (step S105), the CPU 601 terminates the present process.

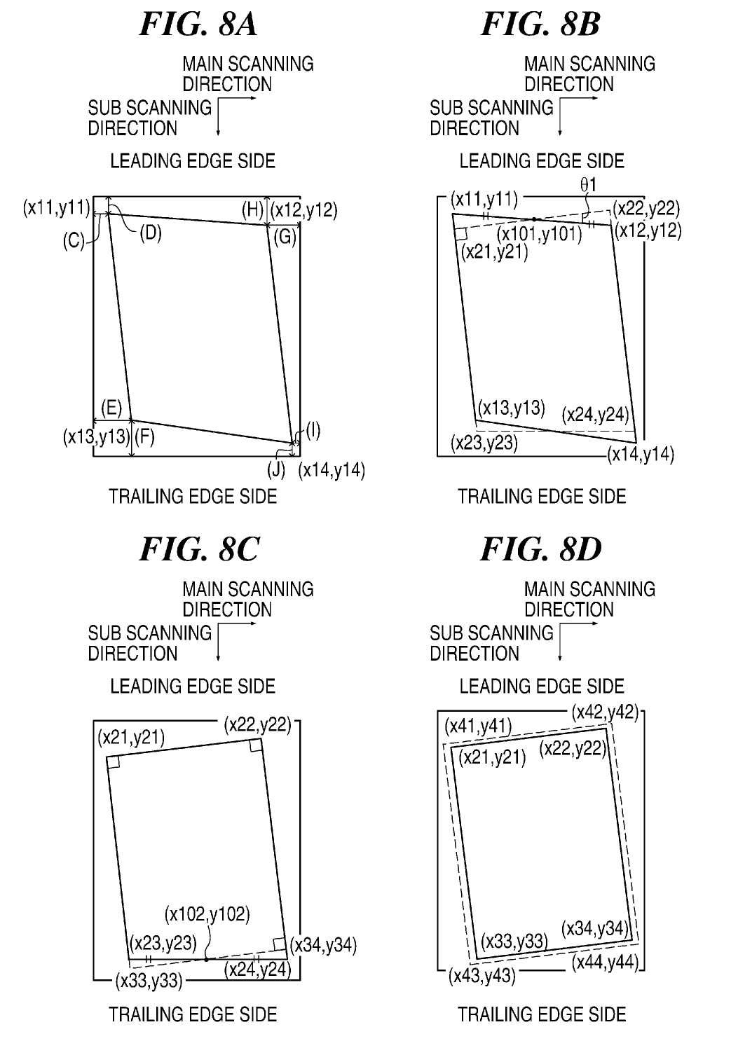

Hereinafter, print position misalignment amount calculation and the print position adjustment process, executed in the step S105, will be described in detail with reference to FIG. 8A to FIG. 13. Note that while skew correction of the image is performed when adjusting the print position, the reference side selected in the reference side selection process performed in the step S102, which is described in detail hereinafter, is used as a reference side for the skew correction.

More specifically, for example, in a case where the left edge has been selected as the reference side in the step S102, the print position misalignment amount calculation and the print position adjustment process are executed as follows.

FIGS. 8A to 8G are diagrams useful in explaining a method of print position misalignment amount calculation and a method of print position adjustment with reference to the left edge. The method of print position adjustment with reference to the left edge is a method in which the print position adjustment is performed by setting the left edge of the sheet P, with reference to which the skew correction in the print position adjustment is performed, as the reference side.

FIG. 8A is a diagram showing an example of results of printing which is performed by the image forming apparatus 400 based on data obtained by reading the front side 801 of the print position adjustment chart (test sheet 800) shown in FIG. 4A. In FIG. 8A, the four corners of an image having a parallelogram shape are represented by distances from the sheet edges of the test sheet 800, denoted by alphabets (C) and (D), (E) and (F), (G) and (H), and (I) and (J) for identifying the four corners of the image, respectively. The four corners of the image are represented by a coordinate system using a certain predetermined position as a reference position, and four coordinate points indicating the four corners of the image are represented by (x11, y11), (x12, y12), (x13, y13), and (x14, y14), respectively.

Next, the coordinates are connected to each other by straight lines, and right-angle correction is performed to make a straight-line segment (one side of the parallelogram shape) connecting the point (x11, y11) and the point (x12, y12) both at a leading edge-side end of the image, at right angles to a straight-line segment (another side of the parallelogram shape) connecting the point (x11, y11) and the point (x13, y13). The point (x11, y11) indicates one of sub scanning writing start positions. More specifically, as shown in FIG. 8B, the straight-line segment connecting the point (x11, y11) and the point (x12, y12) is rotated through an angle of θ1 about a midpoint (x101, y101) of the length of the straight-line segment, such that the point (x11, y11) is changed into a point (x21, y21) at which the one side is at right angles to the other side, to thereby determine a changed sub scanning writing start position. Also, the point (x12, y12) is converted to a point (x22, y22) where the rotated side has the aforementioned length from the point (x21, y21). Further, the point (x13, y13) is converted to a point (x23, y23) to determine a changed sub scanning writing start position. Also, the point (x14, y14) is converted to a point (x24, y24). Thus, changed sub scanning writing start positions of the image at the respective writing start positions in the main scanning direction are determined, whereby the right-angle correction is performed.

Next, trapezoidal correction is performed for making a straight-line segment that connects the point (x23, y23) and the point (x24, y24) at a trailing edge-side end of a trapezoid-shaped image formed by the right-angle correction, at right angles to a straight line extending through the point (x21, y21) and the point (x23, y23).

More specifically, as shown in FIG. 8C, the straight-line segment that connects the point (x23, y23) and the point (x24, y24) is rotated about a mid point (x102, y102) of the length of the straight-line segment, such that the point (x24, y24) is changed into a point (x34, y34) on a straight-line segment at right angles to the one side and connecting the point (x22, y22) and the point (x24, y24), at which a side corresponding to the rotated straight-line segment is at right angles to the straight-line segment connecting the point (x22, y22) and the point (x24, y24), and accordingly, the point (x23, y23) is converted to a point (x33, y33) which is on the side corresponding to the rotated straight-line segment and has the length from the point (x34, y34). By thus changing the positions of the opposite ends of the trailing side of the image, the trapezoidal correction is performed.

Next, as shown in FIG. 8D, magnification correction is performed on a rectangular image formed by the trapezoidal correction, such that the lengths of the image in the main scanning direction and the sub scanning direction become ideal lengths corresponding to an effective area of the sheet P. The ideal lengths of the image in the main scanning direction and the sub scanning direction refer to lengths obtained by subtracting e.g. 2 cm from the respective lengths of the sheet in the main scanning direction and the sub scanning direction.

More specifically, the magnification correction is performed by determining magnifications in the main scanning direction and the sub scanning direction, and thereby converting, with the center of the image as a reference, the point (x21, y21) to a point (x41, y41), the point (x22, y22) to a point (x42, y42), the point (x33, y33) to a point (x43, y43), and the point (x34, y34) to a point (x44, y44).

Next, skew of the image having been subjected to the magnification correction is corrected as shown in FIG. 8E such that a straight-line segment connecting an end point (x103, y103) of the leading edge of the sheet and an end point (x104, y104) of the trailing edge of the sheet, and a straight-line segment connecting the point (x41, y41) and the point (x43, y43) on the image are made parallel to each other. More specifically, the skew is corrected by rotating the image about the point (x41, y41) through an angle θ2 in a clockwise direction to convert the point (x42, y42) to a point (x52, y52). At this time, the point (x43, y43) is converted to a point (x53, y53) and the point (x44, y44) is converted to a point (x54, y54), for the skew correction. Note that in FIG. 8E, the image is rotated using the left edge of the sheet as the reference side, such that the reference side and the image are made parallel to each other.

The reference side is selected based on a sheet side with reference to which skew of the sheet is corrected in post-processing which is physical processing performed on the sheet having the image transferred thereon. More specifically, in a case where the post-processing is punching, the left edge of the sheet is selected as the reference side. This is because in the punching processing, normally, skew of the sheet is corrected using the conveying rollers 902 and 903 arranged such that the sheet is conveyed in a direction skewed with respect to a wall of the conveyance path with which the left edge of the sheet is brought into sliding contact. Further, in a case where the post-processing is book-binding, the leading edge of the sheet is selected as the reference side. This is because in the book-binding processing, normally, skew of the sheet is corrected using the positioning member 523 with which the leading edge of the sheet is brought into abutment. Note that in a case where the post-processing is sorting, the leading edge of the sheet is selected as the reference side, for example. Further, in a case where the post-processing is stapling, an optimum reference side is selected according to a stapling position. This makes it possible to obtain high-quality printed matter of which the skew is corrected and which also gives no feeling of strangeness.

As described above, the CPU 601 selects a reference side according to a type of the post-processing. Alternatively, the CPU 601 selects a reference side according to the configuration of a sheet skew correction section for post-processing. Further, the CPU 601 selects a reference side based on information on a type of the post-processing, which is input by the user from the console section 300.

Next, as shown in FIG. 8F, the print position of an image is corrected such that an image after the correction, shown in FIG. 8G, is obtained in which the four corners of the image have the coordinates (x61, y61), (x62, y62), (x63, y63), and (x64, y64), so as to bring the center of the image to the center of the sheet. Such a print position adjustment process is similarly performed on the reverse side 802 of the test sheet 800 following the print position adjustment process performed on the front side 801 of the test sheet 800.

By performing the print position adjustment process, there are generated conversion conditions (adjustment conditions) for converting the image data such that a position of the image with respect to the sheet becomes ideal. The conversion conditions are stored in the RAM 603 in association with attribute information of the sheet and information on the sheet feeders. When performing print processing, the image processor 610 converts image data according to the conversion conditions stored in the RAM 603, and the CPU 601 controls the printer 100 to form an image on a sheet based on the converted image data.

On the other hand, in a case where the leading edge has been selected as the reference side in the step S102 in FIG. 6, the print position misalignment amount calculation and the print position adjustment process are executed as follows.

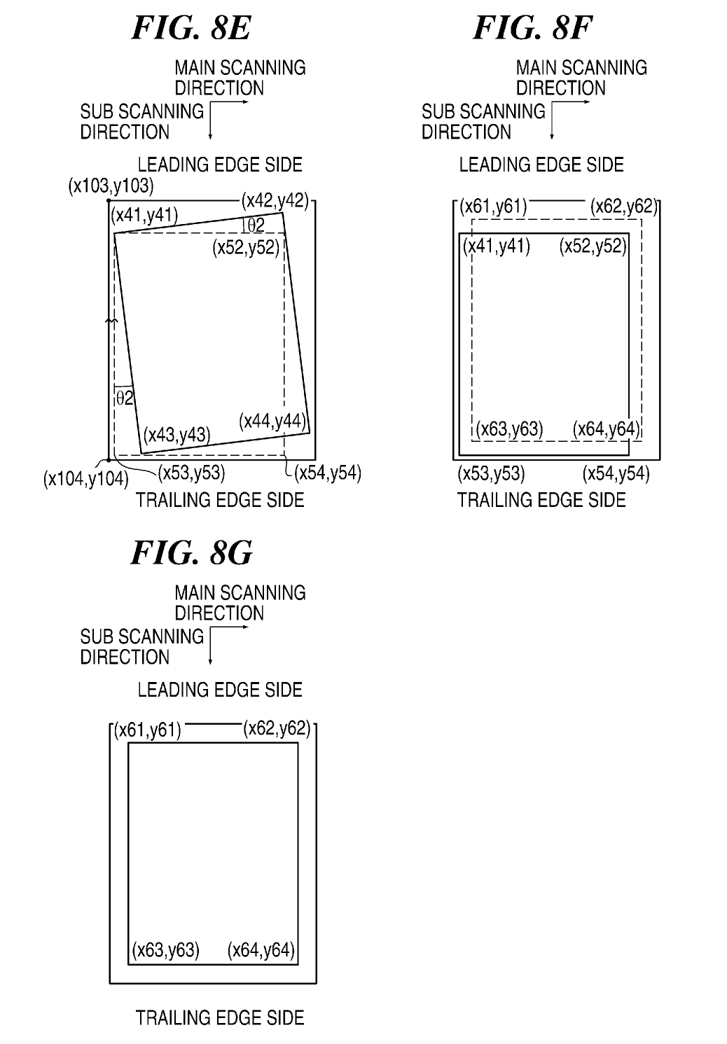

FIGS. 9A to 9G are diagrams useful in explaining a method of print position misalignment amount calculation and a method of print position adjustment with reference to the leading edge. The method of print position adjustment with reference to the leading edge is a method in which the print position adjustment is performed by setting the leading edge of the sheet P, with reference to which skew correction in the print position adjustment is performed, as the reference side.

Since FIGS. 9A to 9D are the same as FIGS. 8A to 8D, description with reference to FIGS. 9A to 9D is omitted, and the description is given with reference to FIG. 9E et seq.

As shown in FIG. 9E, skew of the image having been subjected to the magnification correction is corrected as shown in FIG. 9E such that a straight-line segment connecting the end point (x103, y103) of the leading edge of the sheet and the other end point (x105, y10y), opposite thereto, of the same, and the straight-line segment connecting the point (x41, y41) and the point (x43, y43) on the image are made parallel to each other. More specifically, the skew is corrected by rotating the image about the point (x41, y41) through an angle θ3 in a clockwise direction to convert the point (x42, y42) to a point (x52, y52). At this time, the point (x43, y43) is converted to a point (x53, y53) and the point (x44, y44) is converted to a point (x54, y54), for the skew correction.

In FIG. 9E, the image is rotated using the leading edge of the sheet as the reference side, such that the reference side and the image are made parallel to each other.

Next, as shown in FIG. 9F, the print position of an image is corrected such that an image after the correction, shown in FIG. 9G, is obtained in which the four corners of the image have the coordinates (x61, y61), (x62, y62), (x63, y63), and (x64, y64), so as to bring the center of the image to the center of the sheet. Such a print position adjustment process is similarly performed on the reverse side 802 of the test sheet 800, as required, whereby the print position adjustment is completed. According to the print position adjustment process, a misalignment of a position of an image to be formed on a first surface of the sheet and a position of an image to be formed on a second surface, which is different from the first surface, of the sheet is corrected. By performing the print position adjustment process, there are generated conversion conditions (adjustment conditions) for converting the image data such that a position of the image with respect to the sheet becomes ideal. The conversion conditions are stored in the RAM 603 in association with attribute information of the sheet and information on the sheet feeders. Then, when performing print processing, the image processor 610 converts image data according to the conversion conditions stored in the RAM 603, and the CPU 601 controls the printer 100 to form an image on a sheet based on the converted image data.

Referring again to FIG. 6, on the other hand, if it is determined in the step S101 that the on-line post-processing is not set for the sheet to be subjected to the print position adjustment (NO to the step S101), the CPU 601 proceeds to a step S106. More specifically, the CPU 601 determines whether or not selection of a reference side for print position adjustment is set to be manually made by the user (step S106). In advance or in this step, the CPU 601 displays a screen for designating a reference side selection mode for print position adjustment, on the console section 300, to thereby prompt the user to select one of an automatic mode and a manual mode, as the reference side selection mode.

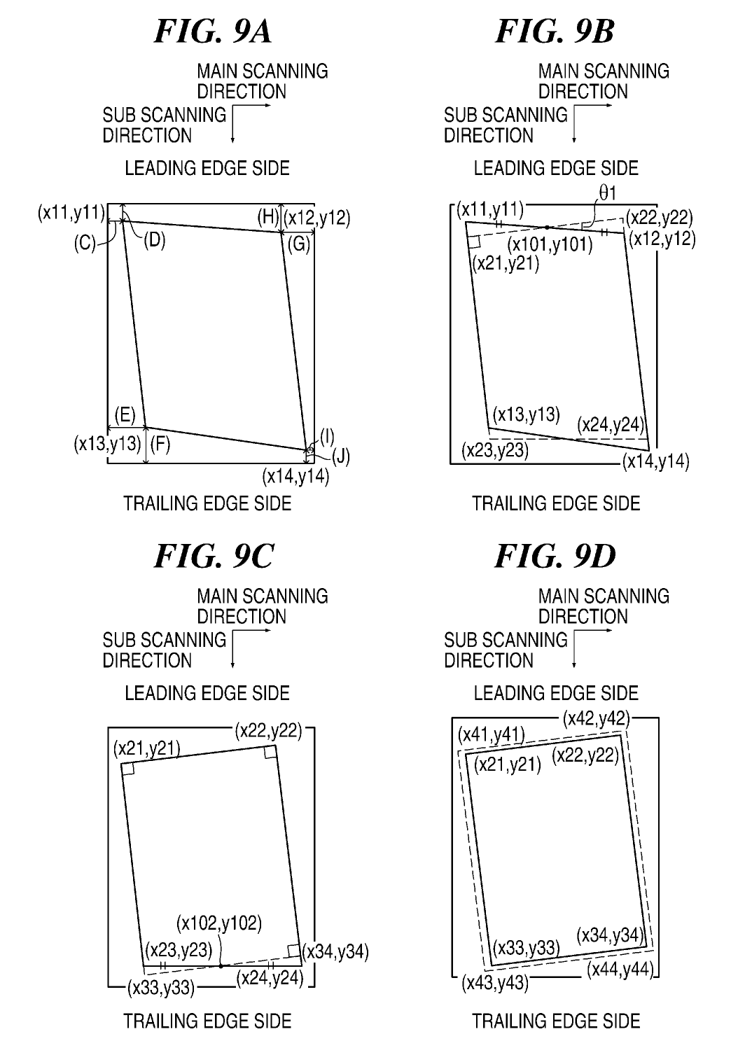

FIG. 10 is a view showing the screen for designating the reference side selection mode for print position adjustment.

Referring to FIG. 10, an automatic button and a manual button are displayed on the reference side selection mode designation screen. By pressing one of the buttons, the user selects to set whether to perform manual selection or automatic selection of a reference side for print position adjustment.

If it is determined in the step S106 that the manual selection of the reference side for print position adjustment by the user has been set (YES to the step S106), the CPU 601 proceeds to a step S107. More specifically, the CPU 601 prompts the user to select a reference side for print position adjustment. To this end, the CPU 601 displays a screen for selecting the reference side for print position adjustment, on the console section 300.

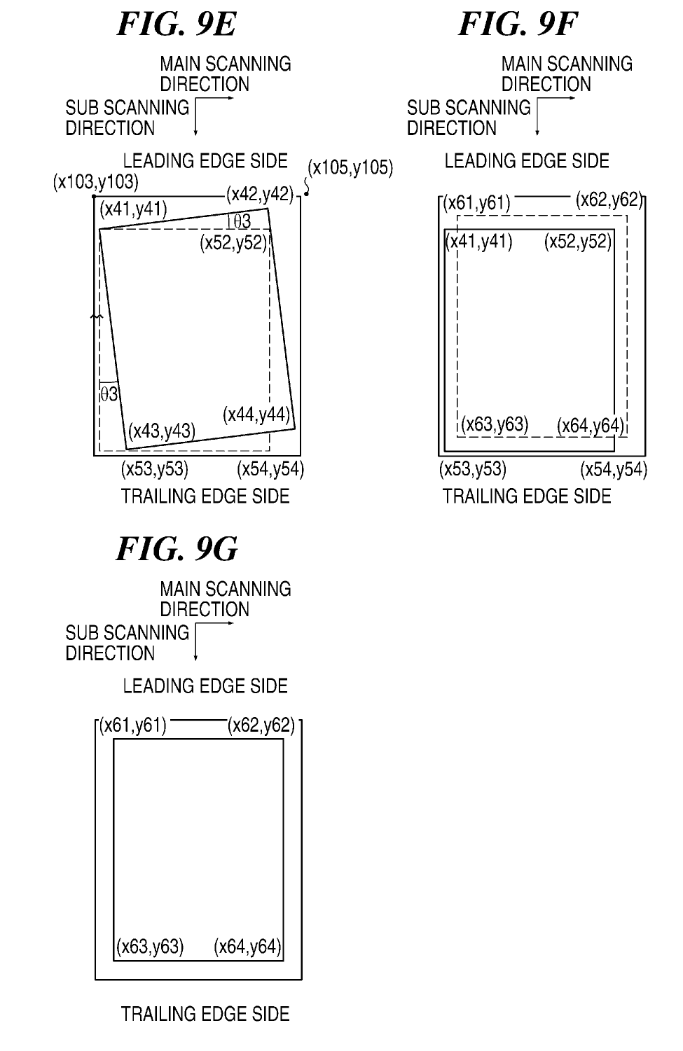

FIG. 11 is a view showing the screen for selecting the reference side for print position adjustment.

Referring to FIG. 11, a leading edge button, a trailing edge button, a right edge button, and a left edge button are displayed on the reference side selection screen for print position adjustment. When a desired one of the buttons is pressed by the user, a side of the sheet to which the image is to be made parallel for print position adjustment is selected as the reference side. Then, the CPU 601 proceeds to the step S103.

By prompting the user to select a reference side for print position adjustment, a variation for making use of the image forming apparatus 400 is increased. More specifically, for example, in a case where a printed sheet delivered from the image forming apparatus 400 is to be cut, normally, the reference side depends on which portion of the sheet is to be cut, because the user desires skew correction of the image to be performed such that the image becomes parallel to a cut side of the sheet. Therefore, in such a case, the user is prompted to select a reference side and give an instruction indicative of the selection via the console section 300, whereby variation for making use of the image forming apparatus 400 is increased. Although the steps S106 and S107 are described based on an example of the case where the user is prompted to select a reference side using the console section 300, the reference side may be selected e.g. by receiving data indicative of the reference side selected by the user from another apparatus via the network, without using the console section 300.

On the other hand, if it is determined in the step S106 that the manual selection of the reference side for print position adjustment by the user has not been set (NO to the step S106), the CPU 601 determines that the automatic selection of the reference side for print position adjustment has been set, and acquires setting information of the reference side stored in the ROM 602 (step S108). Then, the CPU 601 proceeds to the step S103. The setting information of the reference side stored in the ROM 602 is information on the reference side which is determined in advance based on a registration configuration, i.e. the configuration of the sheet skew correction section of the post-processing apparatus.

Note that depending on the type of the post-processing, the post-processing is performed with reference to the left edge of the sheet or with reference to the leading edge of the sheet. For example, in a case where folding processing in which the sheet is folded in half with reference to the leading edge of the sheet is to be performed, the skew correction of the image should be performed with reference to the leading edge. This is because a fold line of the sheet is set such that it becomes parallel to the leading edge of the sheet, and hence unless the leading edge and the image are made parallel to each other, the fold line of the sheet and the image are not kept parallel to each other, which degrades the quality of a deliverable. That is, if the reference side for skew correction of the print image is determined only based on the configuration of the post-processing apparatus, excellent products cannot be necessarily obtained. Therefore, it is preferable to determine a reference side by taking the type of the post-processing as well into account.

Next, a description will be given of the reference side selection process for print position adjustment, which is performed in the step S102 in FIG. 6. The reference side of the sheet with reference to which skew correction for print position adjustment is performed is univocally selected according to processing to be executed as the post-processing which is performed on the sheet subjected to image formation and delivered from the image foaming apparatus.

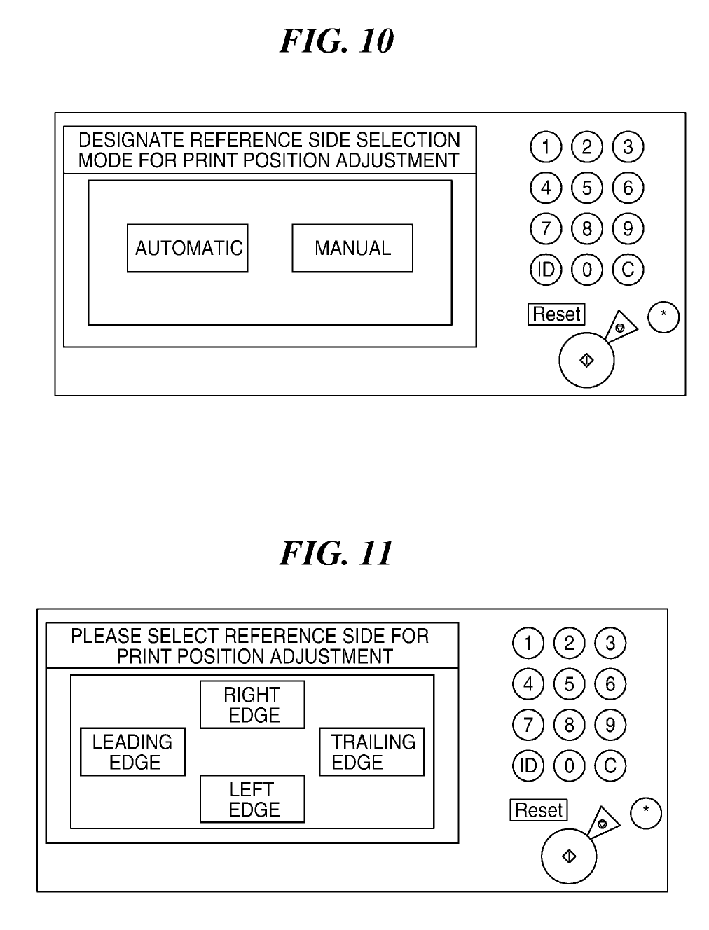

FIG. 12 is a flowchart of the reference side selection process performed in the step S102 in FIG. 6, for print position adjustment. The reference side selection process is performed by the CPU 601 incorporated in the system controller 600 of the image forming apparatus 400 according to a reference side selection processing program for print position adjustment, which is stored in the ROM 602. In the following description, for convenience of explanation, the post-processing is classified into the bookbinding processing by the finisher 500, including the folding processing, and the punching processing by the puncher 900. Note that the post-processing is not limited to the bookbinding processing and the punching processing, but may be the sorting processing, stapling processing, or other processing, as described hereinabove.

Referring to FIG. 12, when the reference side selection process is started, the CPU 601 displays a screen for designating a type of the post-processing on the console section 300, to thereby prompt the user to select the processing to be performed as the post-processing, and determines whether or not the bookbinding processing has been selected (step S201),

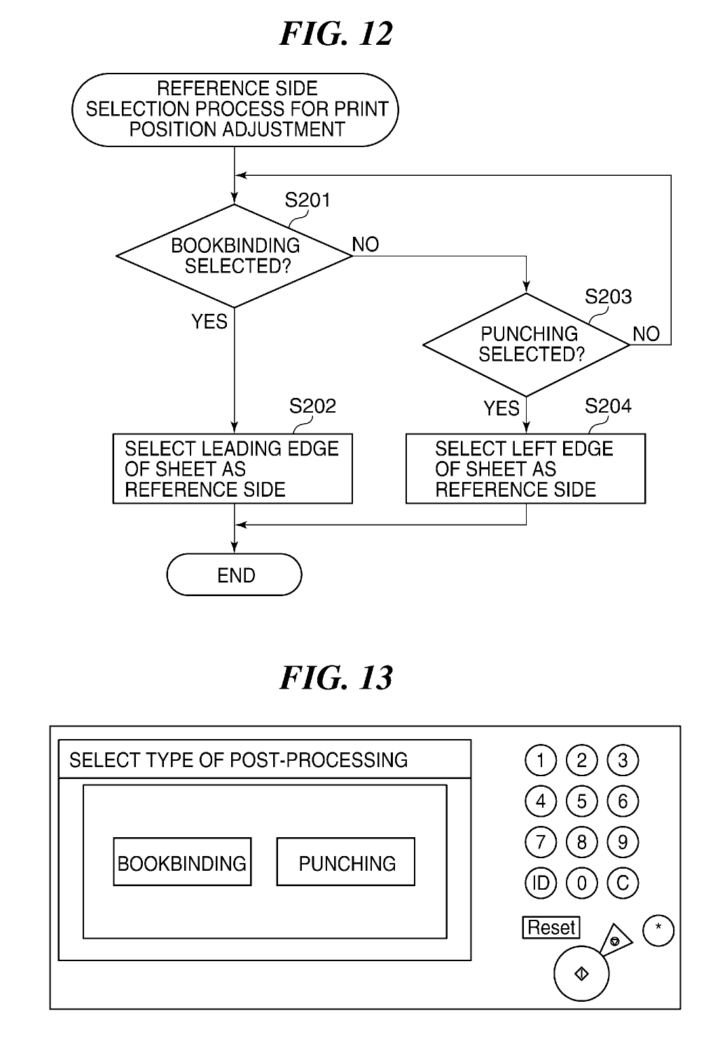

FIG. 13 is a view showing a screen displayed on the console section 300, for selecting processing to be performed as the post-processing. Referring to FIG. 13, as buttons for selecting processing to be performed as the post-processing, for example, a bookbinding button and a punch button are displayed. The user selects the processing to be performed as the prost-processing by pressing one of the bookbinding button and the punch button. Note that the processing to be performed as the prost-processing may be selected not only by the method of selection by the user using the console section 300, but also a method of selecting the reference side e.g. by receiving data indicative of the selection by the user from another apparatus via the network, without using the console section 300.

Referring again to FIG. 12, if it is determined in the step S201 that the bookbinding processing has been selected (YES to the step S201), the CPU 601 proceeds to a step S202, wherein the CPU 601 selects the leading edge of the sheet as the reference side (step S202), followed by terminating the present process.

In the bookbinding processing, as described hereinbefore, the leading edge of the sheet P is caused to be brought into abutment with the positioning member 523 of the finisher 500 (leading edge abutment control), whereby skew of the sheet is corrected. Therefore, in this case, the leading edge of the sheet is selected as the reference side. In a case where post-processing including the leading edge abutment control is performed, by setting the leading edge of each sheet as the reference side in skew correction for print position adjustment, an image on each sheet of the book-bound sheet bundle appears parallel to the leading edge of the sheet, which makes it possible to obtain excellent printed matter which gives no feeling of strangeness.

On the other hand, if it is determined in the step S201 that the bookbinding processing has not been selected (NO to the step S201), the CPU 601 determines whether or not the punching processing has been selected (step S203). If it is determined in the step S203 that the punching processing has been selected (YES to the step S203), the CPU 601 selects the left edge of the sheet as the reference side (step S204), followed by terminating the present process.

As described hereinbefore with reference to FIG. 2, in the punching processing, normally, using the conveying rollers 902 and 903 arranged such that the sheet is conveyed in a direction skewed with respect to the wall of the conveyance path with which the left edge of the sheet is brought into sliding contact, i.e. by left-edge reference control by oblique feed abutment, skew of the sheet is corrected. Therefore, in this case, the left edge of the sheet is selected as the reference side. In a case where the punching processing including the left edge reference control is performed, by setting the left edge of each sheet as the reference side in skew correction for print position adjustment, an image on each punched sheet P appears parallel to the left edge of the same, which makes it possible to obtain excellent printed matter which gives no feeling of strangeness between punched holes formed by the punching processing and the image having been subjected to position adjustment.

On the other hand, if it is determined in the step S203 that the punching processing has not been selected (NO to the step S203), the CPU 601 returns to the step S201.

According to the processes described with reference to FIGS. 6 and 12, when the print position adjustment process is executed by the image forming apparatus 400, the reference side to be applied to skew correction for print position adjustment is selected according to a type of the post-processing (step S102). That is, the reference side is set to a sheet side used for skew correction in the post-processing. This makes it possible to perform print position adjustment using an optimum reference side, and hence after print position correction, it is possible to obtain high-quality printed matter of which the skew is corrected and which also gives no feeling of strangeness.

According to the present invention, in the case where the post-processing including the leading edge abutment control is performed, the leading edge is selected as the reference side (step S202, FIG. 12). With this, an image on each sheet P of a bookbound sheet bundle appears in parallel with the leading edge of the sheet P, so that it is possible to obtain excellent printed matter which gives no feeling of strangeness.

Further, in the case where the punching processing including the left edge reference control is performed, the left edge is selected as the reference side (step S204, FIG. 12). With this, an image on each sheet P subjected to the punching processing appears in parallel with the left edge thereof, and hence it is possible to obtain excellent printed matter which causes no feeling of strangeness between punched holes formed by the punching processing and the image having been subjected to position adjustment.

Further, the image forming apparatus 400 is capable of prompting the user to select a reference side by using the console section 300 (step S107, FIG. 6). This makes it possible to perform skew correction of images, by selecting an optimum reference side according to a type of the post-processing that the user is about to execute, and hence it is possible to obtain printed matter desired by the user.

According to the present invention, the misalignment amount calculation and the print position adjustment are performed using the test sheet, and therefore it is possible to improve the accuracy of the misalignment amount calculation and the accuracy of the print position adjustment. Note that the printer 100 may be configured to include an intermediate transfer drum in place of the intermediate transfer belt 104. The intermediate transfer belt 104 and the intermediate transfer drum function as intermediate transfer members onto which images are transferred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-247816 filed Dec. 21, 2016 which is hereby incorporated by reference herein in its entirety.

What is claimed is:

1. An image forming apparatus comprising:
a conversion unit configured to convert image data based on conversion conditions;
an image forming unit configured to form an image on a sheet based on the image data converted by the conversion unit;
a selection unit configured to select a reference position of the sheet; and
a controller configured to control the image forming unit to form a test image on the sheet, acquire read data related to the test image formed on the sheet by the image forming unit, and generate the conversion conditions based on the read data and the reference position selected by the selection unit,
wherein the test image is used for detecting a misalignment of a position of an image to be formed on a first surface of the sheet by the image forming unit and a position of an image to be formed on a second surface, which is different from the first surface, of the sheet by the image forming unit, and
wherein the read data is output from a reading device.

2. The image forming apparatus according to claim 1, further comprising a post-processing unit configured to perform post-processing on the sheet having the image formed thereon by the image forming unit, based on post-processing information, and
wherein the selection unit selects the reference position corresponding to the post-processing information.

3. The image forming apparatus according to claim 1, further comprising an operation unit configured to input information related to the reference position, and
wherein the selection unit selects the reference position based on the information input by the operation unit.

4. The image forming apparatus according to claim 1, further comprising an operation unit configured to input information related to the reference position, and
wherein the selection unit determines whether or not the reference position is to be manually selected,
wherein the selection unit selects the reference position based on the information input by the operation unit, in a case where the reference position is to be manually selected, and
wherein the selection unit selects a predetermined reference position, in a case where the reference position is not to be manually selected.

5. The image forming apparatus according to claim 1, further comprising a post-processing unit configured to perform post-processing on the sheet having the image formed thereon by the image forming unit, based on post-processing information, and
an operation unit configured to input information related to the reference position, and
wherein the selection unit selects the reference position corresponding to the post-processing information, in a case where the post-processing unit performs post-processing on the sheet, and
wherein the selection unit selects the reference position based on the information input by the operation unit, in a case where an external post-processing apparatus performs post-processing on the sheet.

6. The image forming apparatus according to claim 1, further comprising a post-processing unit configured to perform post-processing on the sheet having the image formed thereon by the image forming unit, based on post-processing information, and
an operation unit configured to input information related to the reference position, and
wherein the selection unit selects the reference position corresponding to the post-processing information, in a case where the post-processing unit performs post-processing on the sheet;
wherein the selection unit determines whether or not the reference position is to be manually selected, in a case where an external post-printing apparatus performs post-processing on the sheet;
wherein the selection selects the reference position based on the information input by the operation unit, in a case where the reference position is to be manually selected, and
wherein the selection unit selects a predetermined reference position, in a case where the reference position is not to be manually selected.

7. The image forming apparatus according to claim 1, further comprising a plurality of post-processing units that perform post-processing on the sheet having the image formed thereon by the image forming unit, the plurality of post-processing units including a first post-processing unit and a second post-processing unit, and
wherein the selection unit selects a first reference position corresponding to the first post-processing unit, in a case where the first processing unit performs post-processing on the sheet, and
wherein the selection unit selects a second reference position corresponding to the second post-processing unit, in a case where the second processing unit performs post-processing on the sheet.

8. The image forming apparatus according to claim 1, further comprising a plurality of post-processing units that perform post-processing on the sheet having the image formed thereon by the image forming unit, the plurality of post-processing units including a first post-processing unit and a second post-processing unit, and
an operation unit configured to input information related to the reference position, and
wherein the selection unit selects a first reference position corresponding to the first post-processing unit, in a case where the first processing unit performs post-processing on the sheet,
wherein the selection unit selects a second reference position corresponding to the second post-processing unit, in a case where the second processing unit performs post-processing on the sheet, and
wherein the selection unit selects the reference position based on the information input by the operation unit, in a case where an external post-processing apparatus performs post-processing on the sheet.

9. The image forming apparatus according to claim 1, further comprising a plurality of post-processing units that perform post-processing on the sheet having the image formed thereon by the image forming unit, the plurality of post-processing units including a first post-processing unit and a second post-processing unit, and
an operation unit configured to input information related to the reference position, and
wherein the selection unit selects a first reference position corresponding to the first post-processing unit, in a case where the first processing unit performs post-processing on the sheet,
wherein the selection unit selects a second reference position corresponding to the second post-processing unit, in a case where the second processing unit performs post-processing on the sheet,
wherein the selection unit determines whether or not the reference position is to be manually selected, in a case where an external post-processing apparatus performs post-processing on the sheet,
wherein the selection unit selects the reference position based on the information input by the operation unit, in a case where the reference position is to be manually selected, and
wherein the selection unit selects a predetermined reference position, in a case where the reference position is not to be manually selected.

10. The image forming apparatus according to claim 1, wherein the controller controls the image forming unit to form a first test image on the first surface of the sheet, and a second test image on the second surface of the sheet.

11. The image forming apparatus according to claim 1, wherein the reference position corresponds to an edge of the sheet.

12. A method of controlling an image forming apparatus that forms an image on a sheet based on image data, comprising:
selecting a reference position of the sheet;
forming a test image on the sheet;
reading the test image formed on the sheet;
generating correction data based on a result of reading of the test image and the reference position; and
performing image processing on the image data based on the correction data, so as to correct misalignment between a position of an image to be formed on a first surface of the sheet and a position of an image to be formed on a second surface, which is different from the first surface, of the sheet.

13. The method according to claim 12, wherein in a case where the reference position is not selected, said selecting includes selecting a predetermined reference position.

14. The method according to claim 12, wherein said forming the test image includes forming a first test image on the first surface of the sheet, and forming a second test image on the second surface of the sheet.

15. The method according to claim 12, wherein said selecting includes selecting an edge from a plurality of edges of the sheet, as the reference position.

16. A method of controlling an image forming apparatus including an image forming unit that forms an image on a sheet, and a first and a second processing units that perform post-processing on the sheet, comprising:
selecting a reference position of the sheet;
forming a test image on the sheet;
reading the test image formed on the sheet;
generating correction data based on a result of reading of the test image and the reference position; and
performing image processing on the image data based on the correction data, so as to correct misalignment between a position of an image to be formed on a first surface of the sheet and a position of an image to be formed on a second surface, which is different from the first surface, of the sheet,
wherein said selecting includes selecting a first reference position in a case where the first post-processing unit performs post-processing on the sheet, and
wherein said selecting includes selecting a second reference position in a case where the second post-processing unit performs post-processing on the sheet.

17. The method according to claim 16, wherein said selecting includes selecting the reference position in a case where a post-processing unit different from the plurality of post-processing units performs post-processing on the sheet.

18. The method according to claim 16, wherein in a case where the reference position is not selected, said selecting includes selecting a predetermined reference position.

19. The method according to claim 16, wherein said forming the test image includes forming a first test image on the first surface of the sheet, and forming a second test image on the second surface of the sheet.

20. The method according to claim 16, wherein said selecting includes selecting an edge from a plurality of edges of the sheet, as the reference position.
